(19) United States
(12) Patent Application Publication
(10) Pub. No.: US 2007/0046428 A1
(43) Pub. Date: Mar. 1, 2007

(54) System and methods for automatically moving access barriers initiated by mobile transmitter devices

(75) Inventors: Jason L. Mamaloukas, Pensacola, FL (US); Paul J. VanDrunen, Navarre, FL (US); Albert W. Mitchell, Cantonment, FL (US)

Correspondence Address: Phillip L. Kenner;RENNER, KENNER, GREIVE, BOBAK, TAYLOR & WEBER, Fourth Floor, First National Tower, Akron, OH, 44308-1456, US

(73) Assignee: Wayne-Dalton Corporation

(21) Appl. No.: 11/211,295

(22) Filed: Aug. 24, 2005

(51) Int. Cl. G05B 19/00

(52) U.S. Cl. 340/5.61; 340/5.71

(57) ABSTRACT

An operator system and related methods for automatically controlling access barriers including a controller associated with at least one access barrier and a transceiver associated with the controller for transmitting and receiving operational signals. The system also includes at least one proximity device capable of communicating operational signals with the transceiver based upon a position of the proximity device with respect to the barrier and/or the operational status of a vehicle carrying the proximity device, wherein the controller monitors the operational signals and controls the position of the access barrier based upon the operation signals. Such a system allows for hands-free operation of the access barrier.

### TECHNICAL FIELD

Generally, the present invention relates to an access barrier control system, such as a garage door operator system for use on a closure member moveable relative to a fixed member and methods for programming and using the same. More particularly, the present invention relates to the use of proximity devices, such as a transponder, to determine the position of a carrying device, such as an automobile, to influence the opening and closing of an access barrier depending upon the position of the carrying device relative to the access barrier. Specifically, the present invention relates to a proximity device that initiates communication with the garage door operator system and thus movement of the barrier depending upon a change in the operational and/or positional status of the carrying device.

### BACKGROUND ART

When constructing a home or a facility, it is well known to provide garage doors which utilize a motor to provide opening and closing movements of the door. Motors may also be coupled with other types of movable barriers such as gates, windows, retractable overhangs and the like. An operator is employed to control the motor and related functions with respect to the door. The operator receives command input signals—for the purpose of opening and closing the door—from a wireless remote, from a wired wall station, from a keyless entry device or other similar device. It is also known to provide safety devices that are connected to the operator for the purpose of detecting an obstruction so that the operator may then take corrective action with the motor to avoid entrapment of the obstruction.

To assist in moving the garage door or movable barrier between limit positions, it is well known to use a remote radio frequency (RF) or infrared transmitter to actuate the motor and move the door in the desired direction. These remote devices allow for users to open and close garage doors without having to get out of their car. These remote devices may also be provided with additional features such as the ability to control multiple doors, lights associated with the doors, and other security features. As is well documented in the art, the remote devices and operators may be provided with encrypted codes that change after every operation cycle so as to make it virtually impossible to “steal” a code and use it a later time for illegal purposes. An operation cycle may include opening and closing of the barrier, turning on and off a light that is connected to the operator and so on.

Although remote transmitters and like devices are convenient and work well, the remote transmitters sometimes become lost, misplaced or broken. In particular, the switch mechanism of the remote device typically becomes worn after a period of time and requires replacement. And although it is much easier to actuate the remote transmitter than for one to get out of an automobile and manually open the door or access barrier, it is believed that the transmitter and related systems can be further improved to obtain “hands-free” operation. Although there are some systems that utilize transponders for such a purpose, these systems still require the user to place an access card or similar device in close proximity to a reader. As with remote transmitters, the access cards sometimes become lost and/or misplaced. A further drawback of these access cards is that they do not allow for programmable functions to be utilized for different operator systems and as such do not provide an adequate level of convenience.

Another type of hands-free system utilizes a transponder, carried by an automobile, that communicates with the operator. The operator periodically sends out signals to the transponder carried in the automobile and when no return signal is received, the operator commands the door to close. Unfortunately, the door closing may be initiated with the user out of visual range of the door. This may lead to a safety problem inasmuch as the user believes that the door has closed, but where an obstruction may have caused the door to open and remain open thus allowing unauthorized access.

U.S. patent application Ser. No. 10/744,180, assigned to the assignee of the present application and incorporated herein by reference, addresses some of the shortcomings discussed above. However, the disclosed system does not provide specific auto-open and auto-close functionality in association with the vehicle's position and operational status. And the disclosed system does not provide for user-changeable sensitivity adjustments. Implementing a hands-free system that has universal settings for all home installations is extremely difficult. If one designs for optimum RF range, then the opening range of the barrier is improved, but in contrast, the closing range ends up being too high. If one does not design for optimum RF range then in worst case home installations, the opening RF range might not be sufficient. In other words, if the RF signal is too strong, the barrier opens at a distance relatively far away, but closes only out of sight of the user. Or, if the RF signal is too weak, then the user must wait for the barrier to open before entering the garage. Situations may also arise where a designated sensitivity level causes the operator to toggle between barrier opening and closing cycles before completion of a desired cycle.

U.S. patent application Ser. No. 10/962,224, assigned to the assignee of the present application and incorporated herein by reference, also addresses some of the shortcomings identified in the aforementioned '180 application. The '224 application discloses a specific embodiment wherein the mobile transponder is directly connected to the ignition system and power source of the carrying device. However, such an embodiment does require a specialized installation and does not permit easy transfer of the transponder between carrying devices. And the known hands-free devices all require periodic transmission of a radio frequency signal from the garage door operator. It is believed that this may lead to increased electrical “noise” pollution which adversely affects nearby electrical communication devices.

Therefore, there is a need in the art for a system that automatically moves access barriers depending upon the direction of travel of a device carrying a proximity device such as a transponder, wherein the transponder initiates the communication sequence. And there is a need for the system to also consider the operational status of the device by use of a sensor that is not directly connected to the carrying device's electrical system. And there is a need for a user-changeable sensitivity adjustment for the proximity device.

### DISCLOSURE OF THE INVENTION

One of the aspects of the present invention, which shall become apparent as the detailed description proceeds, is attained by system and methods for automatically moving access barriers initiated by mobile transmitter devices.

Another aspect of the present invention is attained by an operator system for automatically controlling access barriers, comprising a base controller associated with at least one access barrier; at least one base transceiver associated with the base controller; and at least one remote transmitter periodically generating query signals, the at least one base transceiver in response to the query signals generating acknowledgment signals which are received by the at least one remote transmitter which subsequently generates movement commands to the base controller based upon receipt of a predetermined number of the acknowledgment signals.

### BRIEF DESCRIPTION OF THE DRAWINGS

For a complete understanding of the objects, techniques and structure of the invention, reference should be made to the following detailed description and accompanying drawings, wherein:

FIG. 1 is a perspective view depicting a sectional garage door and showing an operating mechanism embodying the concepts of the present invention;

FIG. 2 is a block diagram of an operator system with a hands free mobile remote transmitter according to the present invention;

FIG. 3 is a schematic diagram of various positions of an exemplary carrying device with respect to an access barrier that utilizes the operator system according to the present invention;

FIG. 4 is a schematic diagram of a vibration sensor incorporated into a mobile or proximity device remote transmitter utilized with the operator system according to the prevent invention;

FIG. 5 is an electrical noise sensor which may be incorporated into the mobile or proximity device transmitter as an alternative to the vibration sensor;

FIG. 6 is an operational flow chart for either of the activity sensors shown and described in FIGS. 4 and 5 to minimize power usage of the mobile remote transmitter;

FIG. 7 is a schematic diagram of an exemplary mobile transmitter connected to the carrying device's power source;

FIGS. 8A and 8B are an operational flowchart illustrating the initial programming and operation of a base operator utilized by the operator system;

FIGS. 9A and 9B are an operational flowchart illustrating the initial programming and use of the mobile transmitter utilized in the operator system;

FIGS. 10A and 10B are an operational flowchart illustrating the initial powering and operation of the mobile transmitter with the operator system, and in particular the implementation of various operational states of the mobile transmitter;

FIG. 11 is an operational flowchart illustrating implementation of a Learn State of the mobile transmitter;

FIGS. 12A and 12B are an operational flowchart illustrating implementation of the Docked State of the mobile transmitter;

FIG. 13 is an operational flowchart illustrating implementation of the Vehicle Leaving State of the mobile transmitter;

FIG. 14 is an operational flowchart illustrating implementation of the Away State of the mobile transmitter;

FIG. 15 is an operational flowchart illustrating implementation of the Closed Door State of the mobile transmitter;

FIG. 16 is an operational flowchart illustrating implementation of the Vehicle Approaching State of the mobile transmitter; and

FIG. 17 is an operational flowchart illustrating implementation of the Open Door State of the mobile transmitter.

### BEST MODE FOR CARRYING OUT THE INVENTION

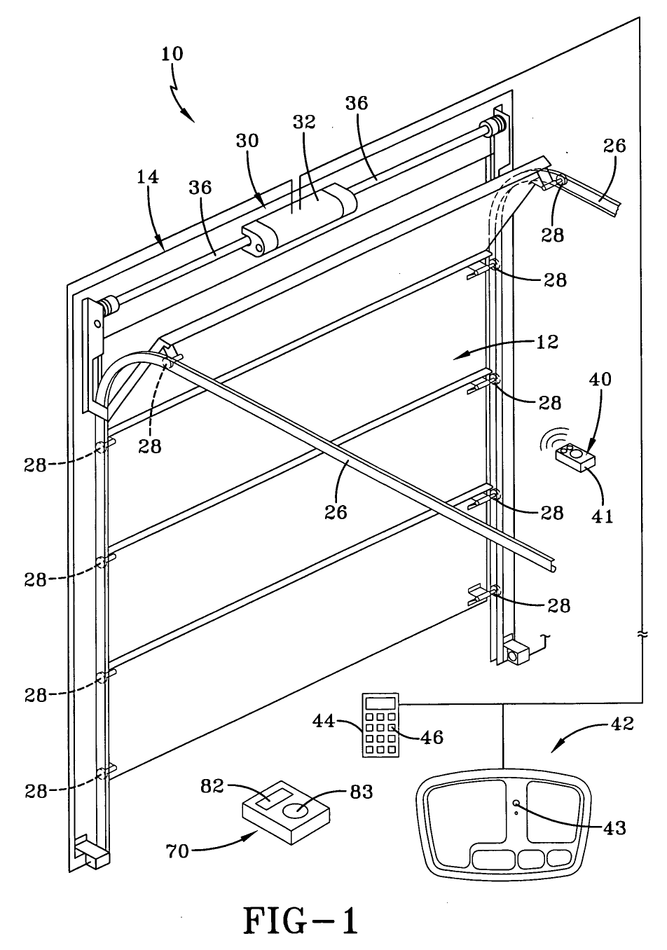

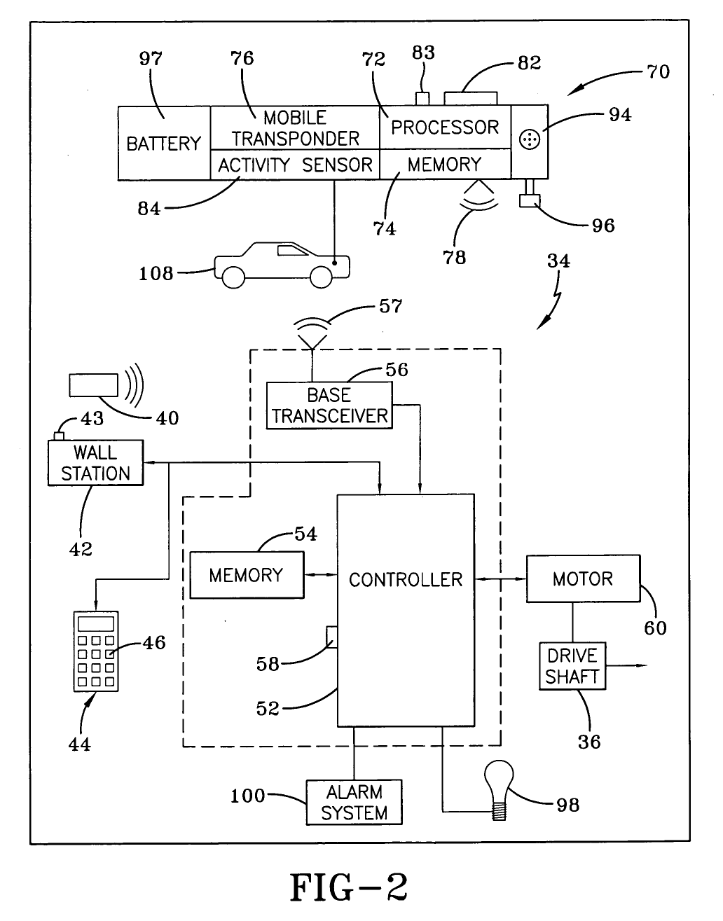

A system, such as a garage door operator system which incorporates the concepts of the present invention, is generally designated by the numeral 10 in FIGS. 1 and 2. Although the present discussion is specifically related to an access barrier such as a garage door, it will be appreciated that the teachings of the present invention are applicable to other types of barriers. The teachings of the invention are equally applicable to other types of movable barriers such as single panel doors, gates, windows, retractable overhangs and any device that at least partially encloses or restricts access to an area. Moreover, the teachings of the present invention are applicable to locks or an automated control of any device based upon an operational status, position, or change in position of a triggering device.

The system 10 is employed in conjunction with a conventional sectional garage door generally indicated by the numeral 12. The opening in which the door is positioned for opening and closing movements relative thereto is surrounded by a frame, generally indicated by the numeral 14. A track 26 extends from each side of the door frame and receives a roller 28 which extends from the top edge of each door section. For vertically moving barriers, a counterbalancing system generally indicated by the numeral 30 may be employed to balance the weight of the garage door 12 when moving between open and closed positions. One example of a counterbalancing system is disclosed in U.S. Pat. No. 5,419,010, which is incorporated herein by reference. An operator housing 32, which is affixed to the frame, carries a base operator 34. Extending through the operator housing 32 is a drive shaft 36 which is coupled to the door by cables or other commonly known linkage mechanism. Although a header-mounted operator is disclosed, the control features to be discussed later are equally applicable to other types of operators used with movable barriers. For example, the control routines can be easily incorporated into trolley type, screwdrive and jackshaft operators used to move garage doors or other types of access barriers. In any event, the drive shaft 36 transmits the necessary mechanical power to transfer the garage door 12 between closed and open positions. In the housing 32, the drive shaft 36 is coupled to a drive gear wherein the drive gear is coupled to a motor 60 in a manner well known in the art.

Briefly, the base operator 34 may be controlled by a wireless remote transmitter 40, which has a housing 41, or a wall station control 42 that is wired directly to the system 30 or which may communicate via radio frequency or infrared signals. The remote transmitter 40 requires actuation of a button to initiate movement of the banner between positions. The wall station control 42 is likely to have additional operational features not present in the remote transmitter 40. The wall station control 42 is carried by a housing which has a plurality of buttons thereon. Each of the buttons, upon actuation, provide a particular command to the controller to initiate activity such as the opening/closing of the barrier, turning lights on and off and the like. A program button 43, which is likely recessed and preferably actuated only with a special tool, allows for programming of the base operator 34 for association with remote transmitters and more importantly with a hands-free proximity device as will become apparent as the description proceeds. The system 30 may also be controlled by a keyless alphanumeric device 44. The device 44 includes a plurality of keys 46 with alphanumeric indicia thereon and may have a display. Actuating the keys 46 in a predetermined sequence allows for actuation of the system 30. At the least, the devices 40, 42 and 44 are able to initiate opening and closing movements of the door coupled to the system 30. The base operator 34 monitors operation of the motor and various other connected elements. A power source is used to energize the elements in a manner well known in the art.

The base operator 34 includes a controller 52 which incorporates the necessary software, hardware and memory storage devices for controlling the operation of the base operator 34 and for implementing the various advantages of the present invention. It will be appreciated that the implementation of the present invention may be accomplished with a discrete processing device that communicates with an existing base operator. This would allow the inventive aspects to be retrofit to existing operator systems. In electrical communication with the controller 52 is a non-volatile memory storage device 54, also referred to as flash memory, for permanently storing information utilized by the controller in conjunction with the operation of the base operator.

Infrared and/or radio frequency signals generated by transmitters 40, 42 and 44 are received by a base transceiver 56 which transfers the received information to a decoder contained within the controller. The controller 52 converts the received radio frequency signals or other types of wireless signals into a usable format. It will be appreciated that an appropriate antenna is utilized by the transceiver 56 for sending and receiving the desired radio frequency or infrared beacon signals 57 back to the various wireless transmitters. The return or reply signals generated by the transceiver 56 may also be referred to as acknowledgment signals. The base transceiver 56 is a Xemics XE 1203F supplied by Xemics of Neuchatel, Switzerland and the controller 52 is a Model MSP430F1232 supplied by Texas Instruments. Of course equivalent transceivers and controllers could be utilized. The base transceiver is directly associated with the base operator 34, or in the alternative, the base transceiver could be a stand-alone device that utilizes a 372 MHz transmitter that communicates with the controller. The base transceiver 56 may also receive and send signals utilizing a 900 MHZ to 950 MHZ frequency which is better suited for exchanging data with other wireless devices. But, by having the transceiver directly associated with the controller they communicate directly with one another and the state of the door may be immediately known.

A sensitivity switch 58 may be associated with the controller 52. The switch 58 allows for about a 13 dBm link quality difference. In other words, a first mode could provide a −109 dBm level, while a second mode could provide a −96 dBm level. In any event, the controller 52 is capable of directly receiving transmission type signals from a direct wire source as evidenced by the direct connection to the wall station 42. And the keyless device 44, which may also be wireless, is also connected to the controller 52. Any number of remote transmitters 40a-x can transmit a signal that is received by the transceiver 56 and further processed by the controller 52 as needed. Likewise, there can be any number of wall stations. If an input signal is received from a remote transmitter 40, the wall station control 42, or a keyless device 44 and found to be acceptable, the controller 52 generates the appropriate electrical input signals for energizing the motor 60 which in turn rotates the drive shaft 36 and opens and/or closes the access barrier. A learn button 59 may also be associated with the controller, wherein actuation of the learn button 59 allows the controller to learn any of the different types of transmitters used in the system 10.

A mobile transmitter 70, which may also be referred to as a hands-free or proximity device transmitter, is included in the system 10 and effectively operates in much the same manner as the other transmitters except direct manual input from the user is not required, although manual input could be provided. As will be discussed in detail, the transmitter 70 initiates movement depending upon its proximity to the controller, the transmitter's direction of travel with respect to the controller and/or the operational status of the vehicle that is carrying the transmitter. The mobile transmitter 70 includes a processor 72 connected to a non-volatile memory storage device 74. As will be discussed in further detail, the memory maintains system mobile state variables, count values, timer values and the like which are utilized to enable operation of the overall system. The mobile transmitter 70 generates a proximity or query signal 78 for communication with the base transceiver and other like devices. It will be appreciated that the signals between the transceiver 56 and the mobile transmitter 70 may be encrypted using well known technologies. The mobile transmitter 70 includes a mobile transceiver which is also referred to as a mobile transponder 76 that is capable of generating the query signal 78 on a periodic basis and responding to the reply signals 57 generated by the base transceiver. The periodic generation of the query signals 78 may be changed depending upon a detected operational status of the carrying device and/or receiving of the reply signals. The transponder 76 may also be capable of accepting a challenge or inquiry from an interrogator —which in this case is the base transceiver 56—and automatically transmitting an appropriate reply in the form of the signal 78. The transponder is a Xemics XE 1203F and the processor 72 is a Texas Instruments MSP4301F232. Of course, other equivalent devices could be used. The processor 72 includes the necessary hardware, software and memory for receiving and generating signals to carry out the invention. The processor 72 and the memory 74 facilitate generation of the appropriate information to include in the query signal 78 inasmuch as one mobile transmitter may be associated with several operators or in the event several mobile transmitters are associated with a single operator. The system will most likely be configured that any door move commands generated by the mobile transmitter can be overridden by any commands received from the wall station transmitter. Of course, any type of transmitter priority scheme could be established.

The mobile transmitter 70 includes a learn/door move button 82 and a sensitivity/cancel button 83 which allows for override commands and/or programming of the proximity device with respect to the controller 52. Generally, the mobile transmitter 70 allows for “hands-free” operation of the access barrier. In other words, the mobile transmitter 70 may simply be placed in a glove compartment of an automobile or other carrying device and communicate with the controller 52 for the purpose of opening and closing the-access barrier depending upon the position of the mobile transmitter 70 with respect to the base transceiver 56. As such, after programming, the user is no longer required to press an actuation button or otherwise locate the transmitter before having the garage door open and close as desired. If needed, manual actuation of the button 82, after programming, may be used to override normal operation of the proximity device so as to allow for opening and closing of the barrier and also to perform other use and/or programming functions associated with the operator system 34. Actuation of the button 83, after programming, provides for temporary disablement of the hands-free features.

The transmitter 70 may utilize an activity-type sensor which detects some type of observable phenomenon such as vibration of the carrying device when energized or detection of electric emissions generated by the vehicle's spark plugs. In the alternative, the mobile transmitter 70 may be connected directly to an engine sensor, such as an accessory switch, of the automobile. The engine sensor, as with the other activity-type sensors, determines the operational status of the carrying device and, along with determining the position of the carrying device, initiates barrier movement based on the input received.

Additional features that may be included with the proximity mobile transmitter 70 are an audio source 94 and a light source 96. It is envisioned that the audio source 94 and/or the light source 96 may be employed to provide verbal instructions/confirmation or light indications as to certain situations that need the immediate attention of the person utilizing the mobile transmitter 70. For example, the light source may be used to provide a warning as to the state of the access barrier. The sources 94 and 96 may also provide confirmation or rejection of the attempted programming steps to be discussed later. All of the components contained with the proximity device transmitter 70 may be powered by a battery used by the carrying device or at least one battery 97 which ideally have a minimum two year battery life.

A light 98 is connected to the controller 52 and may be programmed to turn on and off depending upon the conditions of the proximity device and how it is associated with the controller 52. Likewise, an alarm system 100 may be activated and/or deactivated depending upon the position of the mobile transmitter 70 with respect to the base transceiver 56.

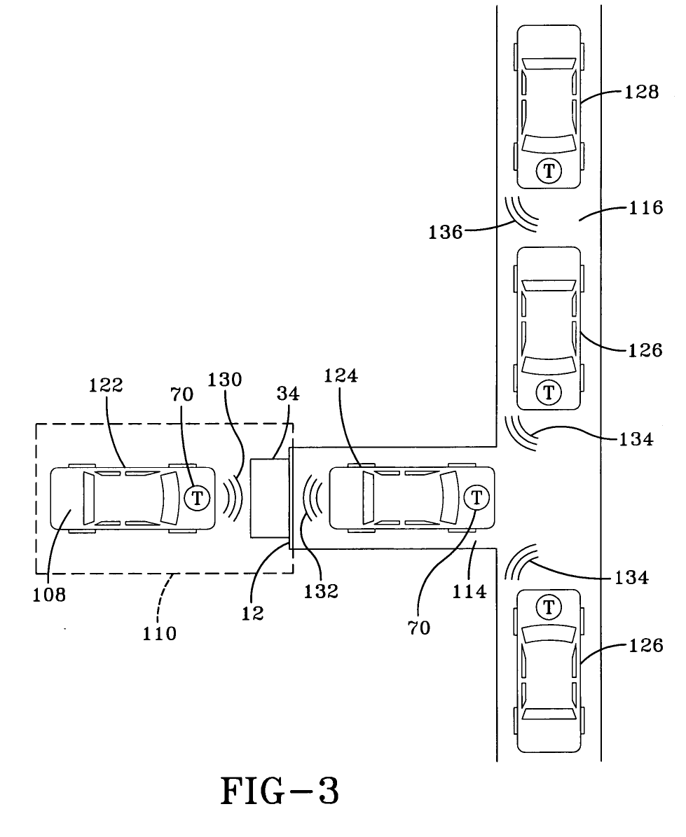

Referring now to FIG. 3, a schematic diagram showing the relationship between a carrying device 108 that carries the mobile transmitter in its various positions and the operator system 34 is shown. Typically, the carrying device is an automobile maintained in a garage or other enclosure generally indicated by the numeral 110. The enclosure 110 is separated from it's outer environs by the access barrier 12 which is controlled by the operator system 34 in the manner previously described. The enclosure 110 is accessible by a driveway 114 which is contiguous with a street 116 or other access-type road.

The carrying device 108 is positionable in the enclosure 110 or anywhere along the length of the driveway 114 and the street 116. The carrying device may be in either a “docked” state inside the enclosure 110 or in an “away” state anywhere outside the enclosure. As the description proceeds, other operational or transitional states of the transmitter 70 will be discussed. As will become apparent, the transmitter 70 initiates communications with the base controller at different power levels. To assist in understanding the states and the power thresholds, specific reference to positions of the carrying device with respect to the enclosure are provided. In particular, it is envisioned that a docked position 122 is for when the automobile or other carrying device is positioned within, or in some instances just outside, the enclosure 110. An action position 124 designates when the carrying device 108 is immediately adjacent the barrier 12, but outside the enclosure and wherein action or movement of the barrier 12 is likely desired. An energization position 126, which is somewhat removed from the action position 124, designates when an early communication link between the mobile transponder 76 and the base transceiver 56 needs to be established in preparation for moving the barrier 12 from an open to a closed position or from a closed position to an open position. Further from the energization position(s) 126 is an away position 128 for those positions where energization or any type of activation signal communicated between the transponder and the operator system is not recognized until the energization position(s) 126 is obtained.

Referring now to FIG. 4, an exemplary detection circuit incorporated into the activity sensor 84 is designated generally by the numeral 200. Generally, after determining whether the carrying device is active, the circuit 200 notifies the processor 72 of the proximity device whether to “Wake Up” or “Go to Sleep.” Thus, the circuit 200 allows a user to go a longer time without changing the batteries of the proximity device. Alternatively, this circuit 200 may allow the use of smaller batteries in proximity devices while still offering users an equivalent battery life.

The detection circuit 200 has three components; a vibration sensor 202, a format circuit 204, and a microprocessor 206. The vibration sensor 202 detects vibrations of the vehicle or carrying device in which the mobile transmitter 70 is located. If placed properly, the vibration sensor 202 determines whether a vehicle's motor is active, even if the motor is merely idling. The vibration sensor 202 may be any element capable of detecting vibration. For example, in one particular embodiment the vibration sensor 202 may be a ceramic piezoelectric element. The vibration sensor 202 generates a vibration signal 208. In some embodiments, this vibration signal 208 will be an analog signal. In other embodiments, the vibration sensor 202 may include an analog-to-digital converter and the vibration signal 208 will be a digital signal. In any event, the vibration signal 208 is received and formatted by the format circuit 204 which prepares the vibration signal 208 for the microprocessor 206. The format circuit 204 receives the vibration signal 208 which may include an amplifier 210. If present, the amplifier 210 could be an op amp, a bipolar junction transistor amplifier, or another circuit that sufficiently amplifies the vibration signal. The amplifier 210 generates an amplified signal 212.

The format circuit 204 may also include a filter 214 . The filter 214 accepts an input signal which may either be the vibration signal 208, or alternatively (if the amplifier 210 is present), the amplified signal 212. In any event, the filter 214 removes unwanted frequencies from the input signal and converts the input signal into a filtered signal 216. Note that the format circuit 204 may include embodiments where the amplifier 210 and filter 214 are transposed.

The format circuit 204 includes an analog-to-digital converter 210 which accepts an analog input signal. This analog input signal may be the vibration signal 208, the amplified signal 212, or the filtered signal 216, depending on the components present in the system. In any event, the analog-to-digital converter 218 converts the analog input signal into a digital signal 220. This digital signal 220 is then received by the microprocessor 206 which may be the same as the processor 72 or otherwise linked thereto. In any event, either or both processors provide the necessary hardware and software to enable operation of the sensor and the system 10. The microprocessor 206 evaluates the digital signal 220 to determine whether the vehicle 108 is active or not. It will be appreciated that the analog-to-digital converter 218 may be either internal or external to the microprocessor 206.

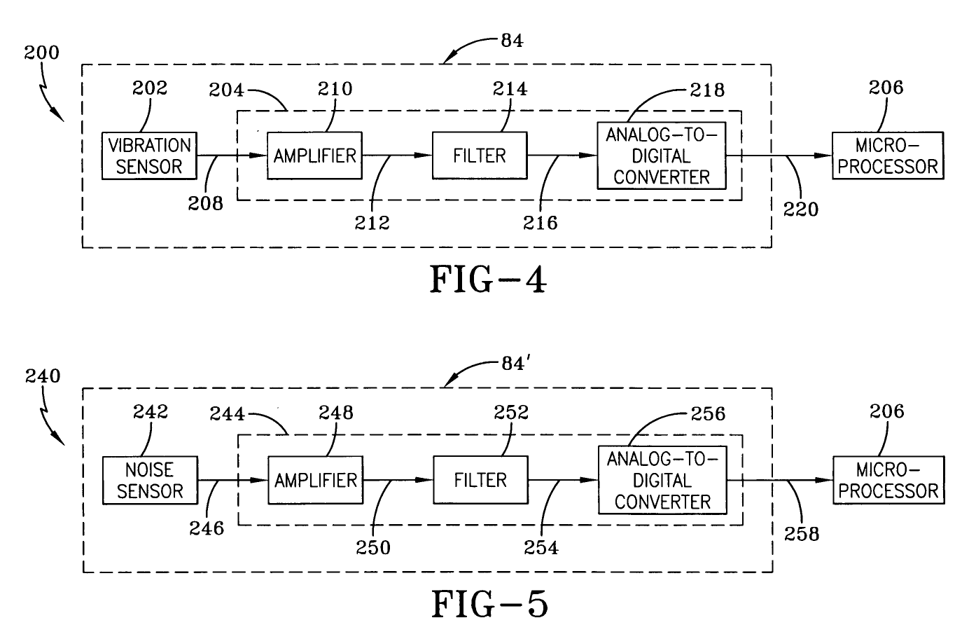

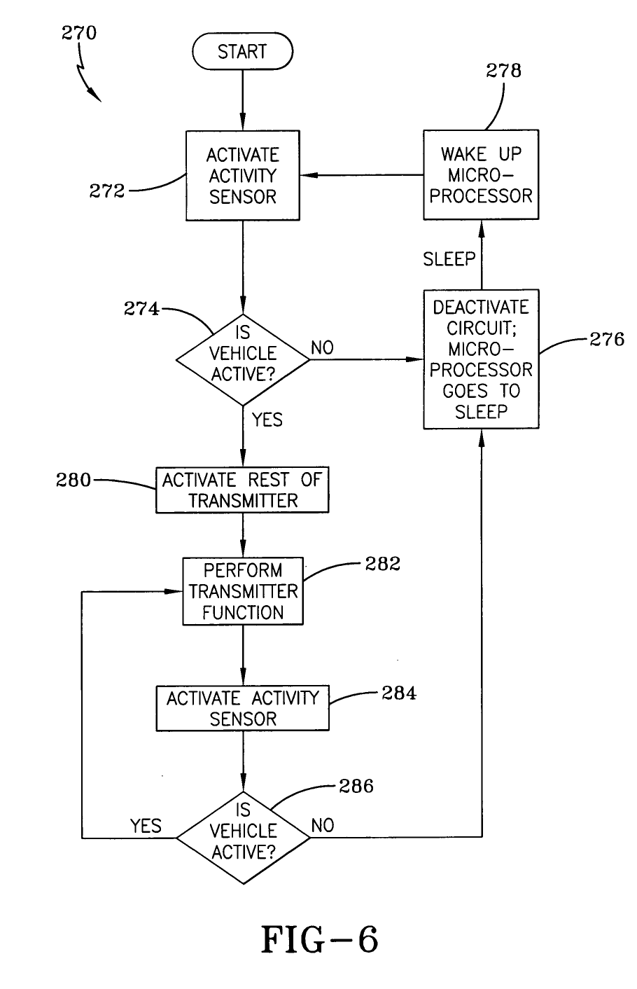

Another embodiment of the present invention may utilize an activity sensor designated generally by the numeral 84′ in FIG. 5 to aid in low-power usage. In such an embodiment, a detection circuit 240 detects whether a vehicle or carrying device is active or not and includes a noise signal sensor 242, a format circuit 244, and the microprocessor 206 which has the same features as in the other sensor embodiment.

The noise sensor 242 detects electromagnetic waves and generates a noise signal 246. The sensor 242 could be an antenna with a simple coil of wire, a long rod, or the like. In understanding how the noise sensor works, it is useful to note that an automobile engine emits a noise signature when it is active. When the engine is not active, it does not emit the same noise signature if at all. For example, the noise sensor 242 may be an amplitude modulation (AM) detector. In other embodiments, the noise sensor 242 can detect a wide bandwidth noise signature from the electric emissions of spark plugs. Spark plugs normally have a repetition rate of around 70 to 210 Hz and about a 25 KV peak volt signal with a rise time in the microsecond range. In any event, the generated noise signal 246 is received by the format circuit 244 which prepares the noise signal 246 for receipt by the microprocessor 206. In one embodiment, the noise signal may be received by an amplifier 248. If present, the amplifier 248 may be an op amp, a bipolar junction transistor amplifier, or another circuit that sufficiently amplifies the noise signal 246 and generates an amplified signal 250.

As with the amplifier 248, the format circuit 244 may have another optional component such as a filter 252 which accepts an input signal. This input signal may be the noise signal 246, or alternatively (if the amplifier 248 is present), the amplified signal 250. In any event, the filter 252 removes unwanted frequencies or irrelevant noise from the input signal and generates a filtered signal 254. It will be appreciated that the amplifier 248 and the filter 252 may be transposed in the format circuit 244.

An analog-to-digital converter 256 receives an analog input signal. The analog input signal may be the noise signal 246, the amplified signal 250, or the filtered signal 254 depending on which components are present in the system. In any event, the analog-to-digital converter 256 converts the analog input signal into a digital signal 258 which is received by the microprocessor 206. The microprocessor 206 evaluates the digital signal 258 and determines whether the vehicle 108 is active or not. It will be appreciated that the analog-to-digital converter 256 may be either internal or external to the microprocessor 206.

Referring now to FIG. 6, the process steps for operation of the activity sensor 84/84′ lo are illustrated in the flow chart designated generally by the numeral 270. As shown, the activity sensor 84/84′ is first activated at step 272. As will be discussed in more detail as the description proceeds, the mobile transmitter 70 is learned to the base operator 34 and various variables and attributes are set internally to enable operation of the system 10. As part of the overall operation, the activity sensor 84/84′ is utilized in such a manner that if the carrying device is determined to be in an “on” condition, then the transmitter 70 automatically generates an initiation or query signal at a specified rate, such as one to sixty times per second. However, if the detection circuit determines that the carrying device is “off,” then the transmitter is placed in a sleep mode so as to conserve battery power and the query signal is generated at a significantly reduced rate such as once per second, if at all.

In particular, at step 274, the microprocessor 206/72 queries the sensor 84/84′ and determines if the vehicle is active or not. In making this determination, the microprocessor evaluates a changing voltage level or a predetermined voltage level according to a programmed detection protocol.

If the vehicle is not active, the microprocessor 206/70 “sleeps” and the rest of the circuit (including the activity sensor and RF transmitter) is deactivated at step 276. Next, the microprocessor periodically wakes up at step 278. This periodic awakening can be accomplished, for example, by programming a watchdog timer or other peripheral to wake up the microprocessor at specified intervals. If the sleep interval is relatively long for the sensor and related circuitry, then the circuit uses relatively little power. After the microprocessor is awakened, the activity sensor is energized again at step 272 and the microprocessor again queries whether the vehicle is active at step 274.

If the vehicle is determined to be active, then the microprocessor activates the mobile transmitter at step 280. Next, the transmitter performs the functions to be described at step 282. As will be described, these functions may include transmitting an RF or other signal to the transceiver of the base operator or receive an acknowledgment signal in return. In any event, after the transmitter performs its function, the microprocessor again activates the sensor at step 284 and queries the sensor to determine if the vehicle is still active or not at step 286. If the vehicle is still active, the microprocessor again performs the transmitter function at step 282. If the vehicle is not active, the process returns to step 276 where the microprocessor deactivates the activity sensor and the rest of the transmitter, and then goes back to sleep.

Optimally, one would want to use a low power microprocessor to maximize the power management of a battery-powered device. Microprocessors enter the sleep mode and are periodically awakened by a watchdog time or other peripheral. While the microprocessor is in sleep mode, it may draw a current of merely a few micro-amps. If one wants to be even more efficient, one could add a switch to the vibration sensor and amplifier to switch off that part of the circuit to minimize current draw during sleep time of the microprocessor. As can be readily seen from this discussion, a long sleep period for the system results in extended battery life.

Those skilled in the art will appreciate that the sensor circuit could be very complex or very simple depending on the quality and signal needed. More appreciated though, will be the simplicity of these sensors that will allow them to be designed for minimal cost impact to the system. The vibration sensor 202 and/or its associated circuitry or the noise signal detector 242 and/or its associated circuitry may be found in the engine compartment of a vehicle, in the mobile transmitter itself, or in some other region in or near the vehicle.

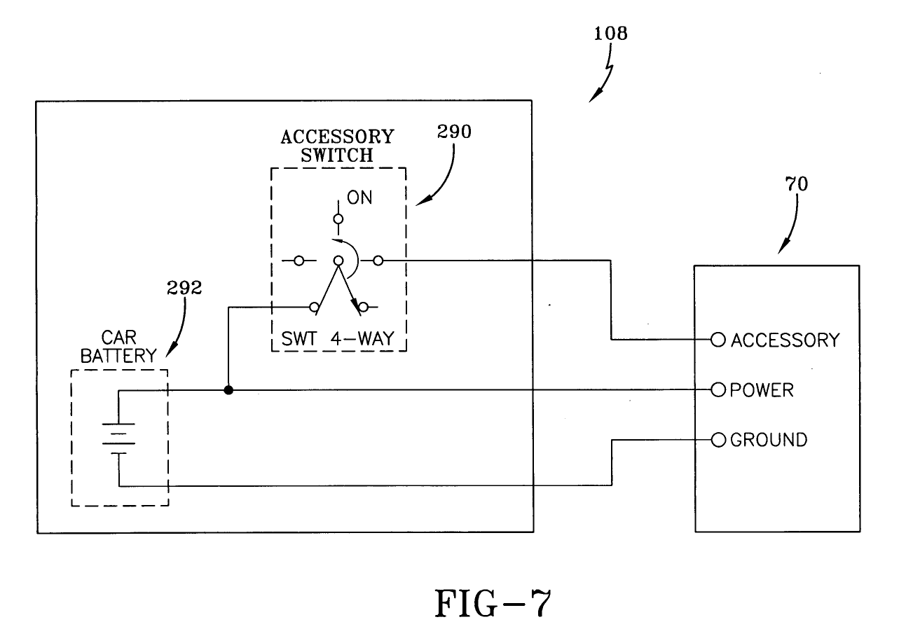

Referring now to FIG. 7, and as previously discussed, the mobile transmitter 70 may be powered by the carrying device 108. In particular, the carrying device 108 includes an accessory switch 290 connected to a battery 292. The accessory switch is a four-way switch with at least an ignition position and an accessory position. The mobile transmitter 70 includes an accessory terminal, a power terminal, and a ground terminal. The battery's ground terminal 292 is connected to the ground of the mobile transmitter and the power terminal is connected to the positive lead of the battery 292. The accessory terminal is connected to the accessory position such that when a key received by the switch is turned to the accessory position, then the mobile transmitter 70 detects such an occurrence and performs in a manner that will be discussed.

Having the mobile transmitter 70 connected directly to the power supply in a vehicle provides advantages over a solely battery-powered proximity device. The three-wire configuration may be employed wherein a single wire provides constant power from the vehicle's battery. Another wire connects the accessory switch to the vehicle and as such powers the proximity device, and a third wire provides the common ground connection to the vehicle. All three of these signals are normally found in an automobile or electric vehicle. This three-wire set-up could possibly be minimized to a two-wire set-up if the common/ground is attached to a conductive chassis of the vehicle. In any event, the mobile transmitter draws power from the constant power supply of the vehicle and uses the accessory circuit as a means of detecting of when the vehicle is energized. By employing such a configuration, there is no need to worry about a “sleep time” for the transmitter device since it is now powered directly by the vehicle battery. As such, the power supply is connected to the mobile transmitter at all times. If the accessory switch is on, the mobile transmitter remains in an active state. However, if the accessory device is off, the proximity device enters a sleep mode to minimize current draw from the vehicle's battery. And it will further be appreciated that the mobile transmitter always has the ability to relay any change of state (active/sleep) information to the base transceiver maintained by the operator just as if the door move button had been manually actuated. By having the mobile transmitter wired direct to the accessory switch, it is possible to have extra features such as an auto-open and auto-close functionality for the garage door operator. As will be described in detail below, detection of the vehicle changing from an off-state to an on-state while the carrying device is within the garage and the barrier is closed, automatically causes the barrier to open. And if the carrying device is moved into the garage and the accessory switch is then turned off, the auto-close feature automatically closes the barrier after a predetermined period of time. For example, for the auto-open feature, the user enters their car and then turns on the ignition. The mobile transmitter would detect that the accessory position—not the ignition position—is now energized and activates the rest of the circuit. The mobile transmitter then transmits a signal to the base transceiver relaying the information that the vehicle or carrying device is now active. Accordingly, the controller associated with the base transceiver would receive this information, adjust any system variables as needed, and transmit a “door open” command to the operator to open the barrier. At any time after activating the accessory circuit, the person can start the vehicle and leave the enclosed area. This method eliminates the need for a carbon monoxide (CO) sensor. When the ignition is turned on, the barrier will open to prevent accumulation of carbon monoxide, and when turned off, the barrier will close.

The auto-close feature would work in the following sequence. The user would park the vehicle in the garage and turn the vehicle off. The mobile transmitter would detect that the accessory switch is off and before the mobile transmitter begins a sleep procedure it will transmit the change in status to the base transceiver. The base transceiver would then change the system variables as needed and then transmit a “door close” command to the operator to close the door. Upon completion of the door closure operation, the mobile transmitter would enter a sleep mode.

As discussed in FIGS. 4-7, various types of sensors may be utilized in conjunction with the mobile transmitter device. The mobile transmitter utilizes an activity sensor to determine when the car is running. In particular, the vibration sensor or electrical noise sensor detects some phenomenon generated by the moving device to indicate that is in an operative condition. The ignition sensor—described in regard to FIG. 7—is directly connected to the electrical operating system of the carrying device and also provides an indication as to its operating state. It will be appreciated that the ignition sensor easily facilitates the use of an auto-open or auto-close command that can be transmitted to the base transceiver 56.

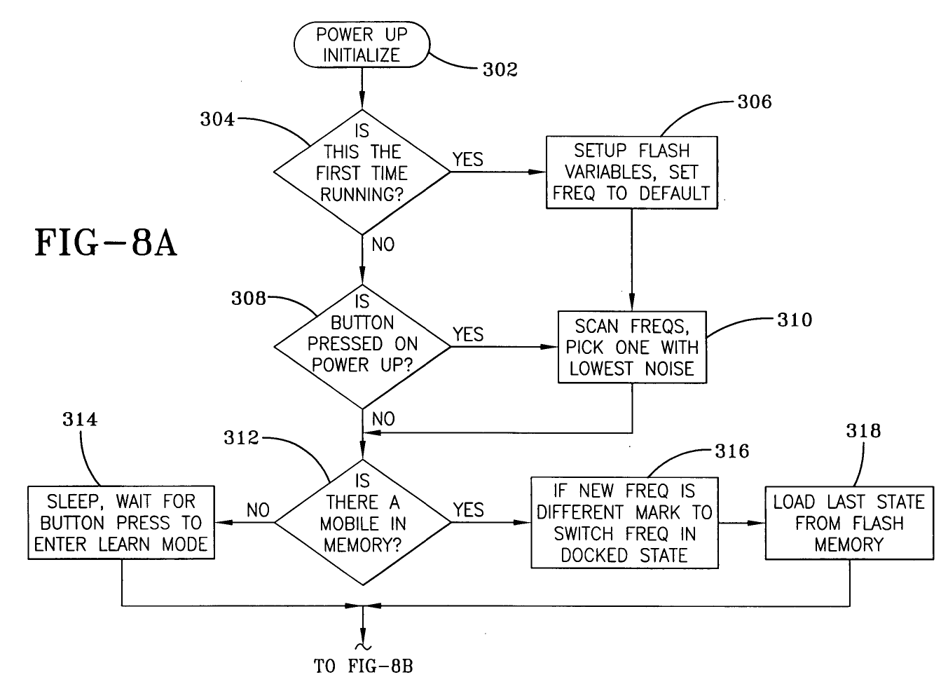

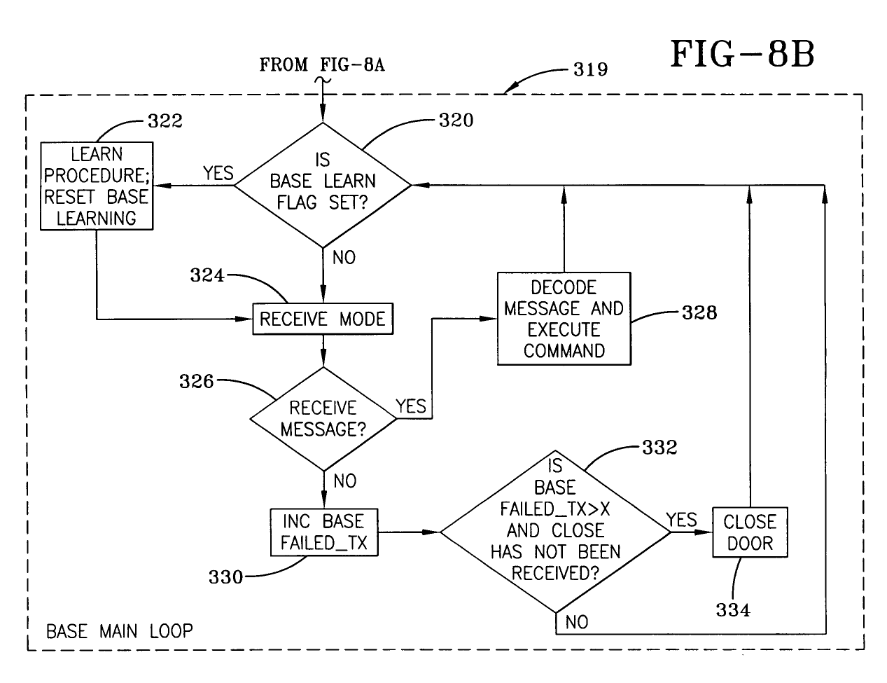

The processes described in relation to FIGS. 8-17 are directed to enabling the mobile transmitter to control operation of the base controller 52. Generally, the mobile transmitter 70 determines whether the carrying device is active and initiates communications with the base controller 52 via the base transceiver 56. The mobile transmitter 70 is capable of generating various different transmit power levels and utilizes count variables for sending different power level signals to the base controller at an appropriate time. In response to the query signals generated by the mobile transmitter, the base controller 52 responds with acknowledgment signals. Based upon these acknowledgment signals, the mobile transmitter generates the appropriate door move commands which are received and acted upon by the base controller 52 and in particular the base operator 34. In some embodiments, the base controller may know the door's position and ignore a door move command if the door is already in the desired position. The base controller may also override some or all of the commands received from the mobile transmitter, inasmuch as the command signals from other types of transmitters may have priority over those of the mobile transmitter.

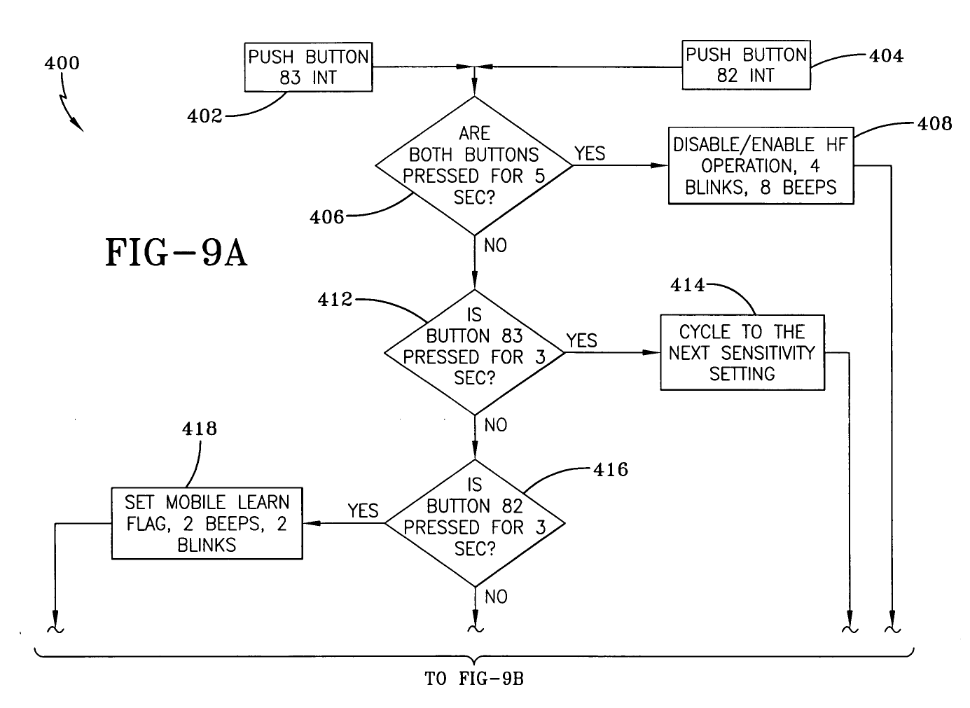

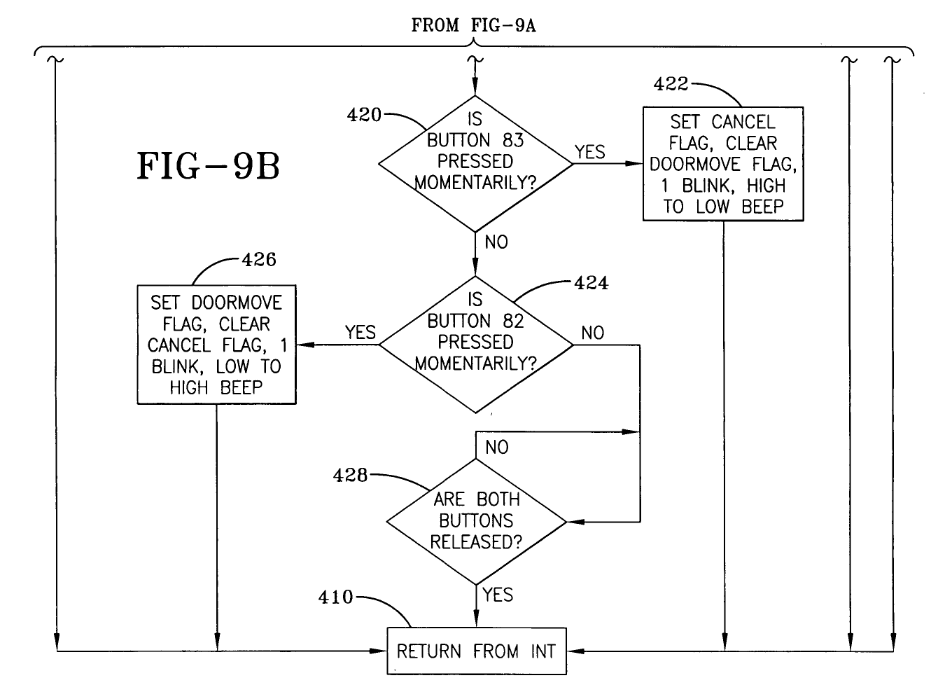

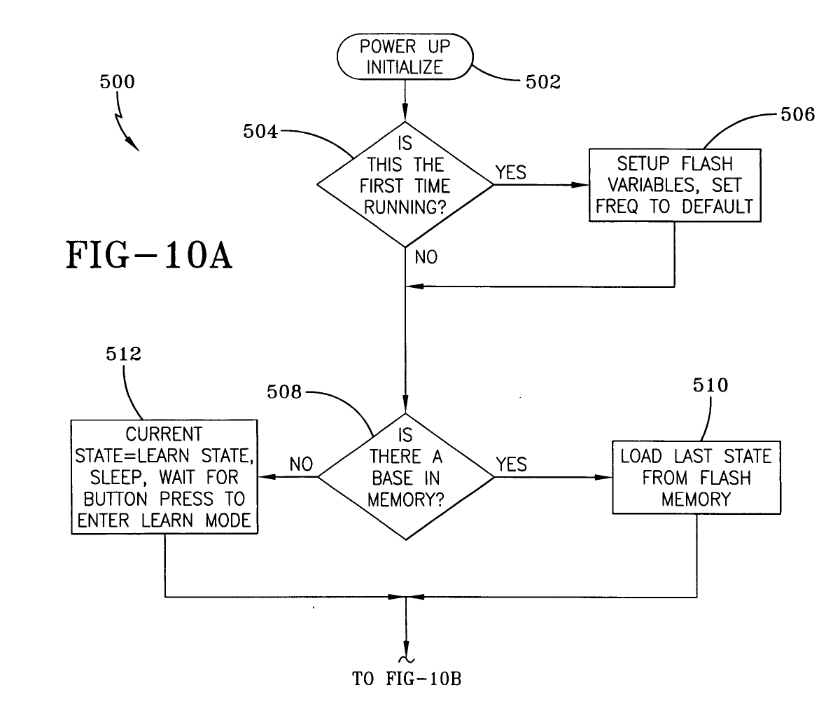

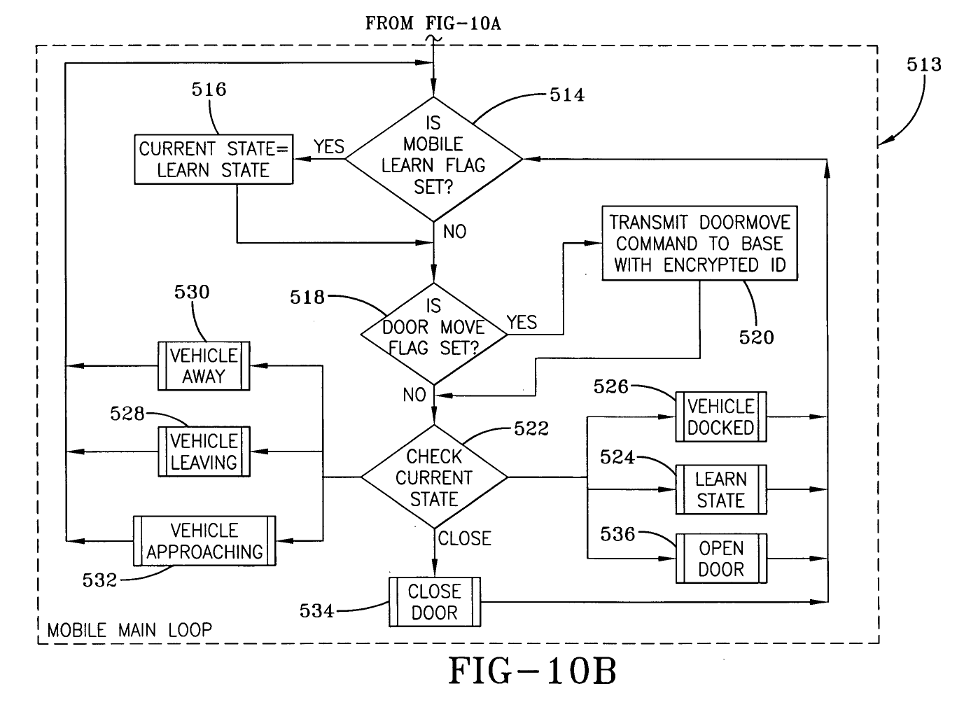

In the following flow charts, it will be appreciated that FIG. 8 describes the operation of the base controller 52 with respect to the learning of a mobile transmitter 70 thereto. FIG. 9 sets forth the operations of the mobile transmitter as it relates to button commands for programming or setting the desired sensitivity. The sensitivity level sets power levels to initiate an approximate range as to when a door is to be opened or closed. And the sensitivity level may dictate values for variable counters used for system sensitivity. In other words, system sensitivity refers to the ability of the transmitter to initiate open and close door commands based upon acknowledgment signals received from the base controller. For example, sensitivity settings may be very different for opening a garage door that is associated with a short driveway as opposed to one that has a very long driveway. Sensitivity settings may also be adjusted according to whether the garage door is located in an electrically noisy environment. Finally, FIGS. 10-17 provide for describing the operational steps undertaken by the mobile transmitter inasmuch as seven operating states are utilized for communicating with the base controller.

Referring now to FIGS. 8A and 8B, it can be seen that a methodology for operation of the base operator controller 52 is designated generally by the numeral 300. Initially, at step 302 power is supplied to the base operator and certain parameters maintained by the controller are initialized. At step 304 the controller 52 determines whether this is the first cycle of operation for the base operator 34. If so, then at step 306 the flash memory maintained by the operator controller is set up and a frequency of operation is set to a default value. If it is determined at step 304 that it is not the first time for running of the base operator, the controller then inquires as to whether a button, such as button 58, is pressed upon application of power to the operator controller. If so, then at step 310, which is also performed upon completion of step 306, the operator controller, in conjunction with the transceiver 56 scans a range of frequencies and picks a selected range of frequency with the lowest noise. It will be appreciated that the devices selected for use with the base station and the remote transmitter fall under certain Federal Communications Commission (FCC) guidelines. Accordingly, the operator controller scans frequencies from 902 MHZ to 928 MHZ every 0.5 MHZ for a total of 52 available channels and the lowest noise channel is selected. It will be appreciated that the 0.5 MHZ range may be adjusted so as to provide for more or less channels as needed. In any event, upon completion of step 310, or if the button 58 is not pressed on power up, the process continues to the next step. At step 312, the controller 52 determines whether a mobile transmitter has been stored in memory 54 or not. If a mobile device is not detected, wherein the mobile device presumably has a unique identification code so that it can be distinguished from other types of transmitters learned to the operator, then at step 314 the controller enters a sleep mode and waits for a button press to initiate a controller learn mode. As will be discussed in further detail, if a mobile transmitter is not saved in memory 54, the base operator will start in a Learn State where the controller will sleep until a button is pressed. If at step 312 it is determined that a mobile device is stored in memory, then at step 316, if the frequency selected is different, a new frequency may be selected and a flag is set to switch the frequency when the mobile transmitter is in a Docked State. Next, at step 318, the last state of the mobile transmitter is loaded from the flash memory and stored.

Upon completion of either step 314 or 318, the base controller enters a base main loop designated generally by the numeral 319. The main loop 319 is performed during normal operation of the operator controller and the mobile transmitter. In particular, at step 320 the controller determines whether a base learn flag has been set or not. If the base learn flag has been set, which is done by initiating a learn command by holding down a button such as button 58 or some other button, or sequence of button actuations, then the base controller undergoes the learn procedure as designated at step 322. Upon completion of step 322, the base learn flag is reset. Upon completion of step 320 or 322 the controller goes into a receive mode at step 324. Next the controller, at step 326, determines whether a message has been received from the mobile transmitter or not. If a message has been received, then at step 328 the message is decoded and the appropriate command is executed. Upon completion of step 328 the process returns to step 320. However, if at step 326 no message is received, then at step 330 a base failed-tx variable is incremented by one and then at step 332 the base operator controller makes a comparison as to whether the failed-tx count is greater than a variable X, which is maintained in the base memory 54. An inquiry is then made as to whether a close door command has not been received. In other words, as will become appreciated as the description proceeds, if the mobile transmitter is out of range before sending a close command signal, the base operator will time out according to variable X and then at step 334 the operator executes a close door command. Upon completion of step 334, or if the criteria of step 332 have not been met, then the process returns to step 320.

Referring now to FIGS. 9A and 9B, it can be seen that a methodology for actuations of the buttons provided by the mobile transmitter 70 is designated generally by the numeral 400. As discussed previously, the mobile transmitter 70 includes a learn/door move button 82 and a sensitivity/cancel button 83. Accordingly, if the sensitivity/cancel button 83 is actuated at step 402, or if the learn/door move button 82 is actuated at step 404, then the processor 72 makes an inquiry as to whether both buttons 82/83 have been pressed for five seconds or some other predetermined period of time at step 406. If so, operation of the mobile transmitter 70 is toggled between disablement or enablement and this is confirmed by the four blinking and eight beeps generated by the audio and light sources 94 and 96 respectively. It will be appreciated that other confirmation signals or sequence of beeps and blinking could be used. In any event, upon completion of step 408 the process proceeds to step 410 and the mobile transmitter 70 awaits a next button actuation or an acknowledge signal from the base operator.

If at step 406 the buttons 82 and 83 are not pressed for the predetermined period of time, then the processor 72 inquires at step 412 as to whether the sensitivity/cancel button 83 has been pressed for a predetermined period of time such as three seconds. If the button 83 is held for more than three seconds, then at step 414 the processor 72 allows for cycling to a desired sensitivity setting. It will be appreciated that the mobile transmitter may be provided with two or more transmit power levels. In this embodiment, there are four power levels available and a different setting can be used for an open door command and a door closed command such that a total of sixteen different sensitivity settings could be established. For example, the four power levels may be designated—from lowest to highest—as P0, P1, P2 and P3. Accordingly, one sensitivity setting could be OPEN=P0, CLOSE=P3; and another as OPEN=P1, CLOSE=P3 and so on for a total of sixteen available settings. If at step 412 it is determined that button 83 has not been pressed for more than three seconds, the process continues to step 416 to determine whether learn/door move button has been pressed for a predetermined period of time, such as three seconds, or not. If the learn/door move button has been pressed for more than three seconds, then at step 418 the mobile learn flag is set and this is confirmed by the beeping of the audio source 94 twice and the blinking of the light source 96 twice. Upon completion of the confirmation, the process proceeds to step 410 and normal operation continues. If, however, at step 416 it is determined that the learn/door move button has not been pressed for three seconds, then the process continues to step 420 where the processor 72 determines whether the sensitivity/cancel button has been momentarily pressed or not. If the button 82 has been pressed, then at step 422 a cancel flag is set, a door move flag is cleared, and a confirmation signal is generated in the form of one blink by the light source 96 and a high to low beep generated by the audio source 94. This step allows the base operator to ignore the next door move command that might otherwise be generated by the mobile transmitter. And then the process is completed at step 410.

If at step 420 the sensitivity/cancel button 83 is not pressed momentarily, then the process inquires as to whether the learn/door move button 82 has been momentarily pressed or not at step 424. If the button 82 has been momentarily pressed, then at step 426 the door move flag is set, the cancel flag is cleared and a confirmation is provided in the form of one blink and a low to high beep or audio tone. This step allows for execution of a manual door move command if desired. If button 82 is not momentarily pressed at-step 424, then the processor, at step 428, awaits for both buttons to be released. Once this occurs then the process is completed at step 410.

Referring now to FIG. 10, it can be seen that a mobile operation flowchart is designated generally by the numeral 500. It will be appreciated that operation of the mobile transmitter utilizes various variables, counters, flags and the like which are maintained by the processor 72. Accordingly, various types of variables and counters will be referred to in operation of the following flowcharts and the use of those variables, although not immediately apparent, will become apparent as the detailed description proceeds. In any event, on first power up, or initialize, at step 502, the processor 72 queries as to whether this is the first time for the mobile transmitter to be operating. If the answer to this query at step 504 is yes, then at step 506 the various set up variables are established in the flash memory 74 and the frequency operation of the transmitter is set to a default value. This default frequency value will be the same as that used by the base operator. Those skilled in the art will appreciate that the use of flash memory allows for these variables and settings to be stored even if power utilized by the mobile transmitter is removed. By utilizing predetermined or preset variables the mobile transmitter is enabled in a basic function operation condition. Upon completion of step 506, or if step 504 determines that the mobile transmitter is not operating for the first time, the process continues to step 508. At this time, the processor 72 determines whether there is a base operator identification code stored in the memory 74. If it is determined that there is a base operator identification code stored in the memory, then at step 510 the last state stored in the memory device is loaded into a variable called “Current State.” If at step 508 it is determined that there is no base operator identification code stored in memory, then at step 512 the Current State variable is set to Learn State and the mobile device is put into a sleep mode and awaits for actuation of the learn button 82. It will be appreciated that the memory of the mobile transmitter maintains a learn flag that is set by a user after initiating a learn cycle by holding down the learn button 82 as described in regard to FIG. 9.

Upon completion of either step 510 or step 512, the process enters a mobile main loop designated generally by the numeral 513. Operation of the remote transmitter 70 stays in the main loop 513 until such time that power is removed. In the main loop 513, the processor determines at step 514 as to whether the mobile learn flag variable has been set or not. If the mobile learn flag has been set, then at step 516 the variable Current State is changed to Learn State. Upon completion of the step 516 or if the mobile learn flag has not been set, the procedure, at step 518 queries as to whether a door move flag has been set at or not. Setting of the door move flag may be done by manual actuation of the button 83. Accordingly, actuation of the button 83 causes the mobile transmitter 70 to operate much like known remote transmitters wherein actuation of a button initiates a door move command. Accordingly, if the door move flag is set at step 518, then at step 520 the transmitter 70 generates a door move command to the base operator with the appropriate encrypted identification. If the base controller determines that the encryption identification code is stored in the memory of the base controller 52, then the move command is executed. If at step 518 a door move flag is not set, or upon completion of step 520, the process continues to step 522 where the processor 72 checks the Current State variable to determine what action or series of actions need to take place. Accordingly, it will be appreciated that the mobile transmitter 70 is set up as a state machine with at least seven states that correspond to what the mobile transmitter is doing at the time. Accordingly, these states are designated as the Learn State 524, the Vehicle Docked State 526, the Vehicle Leaving State 528, the Vehicle Away State 530, the Vehicle Approaching State 532, the Close Door State 534, or the Open Door State 536. Each of the states initiates specific steps and upon completion of any one of the routines returns to step 514 to determine whether a mobile learn flag has been set or not. And then these steps are repeated. It will also be appreciated that the steps 514-522 may be executed at an increased rate whenever the activity sensor 84/84′ determines that the carrying device is in an on condition. If the remote transmitter 70 is connected to the ignition system, steps 514-522 may only be executed when the ignition is determined to be on.

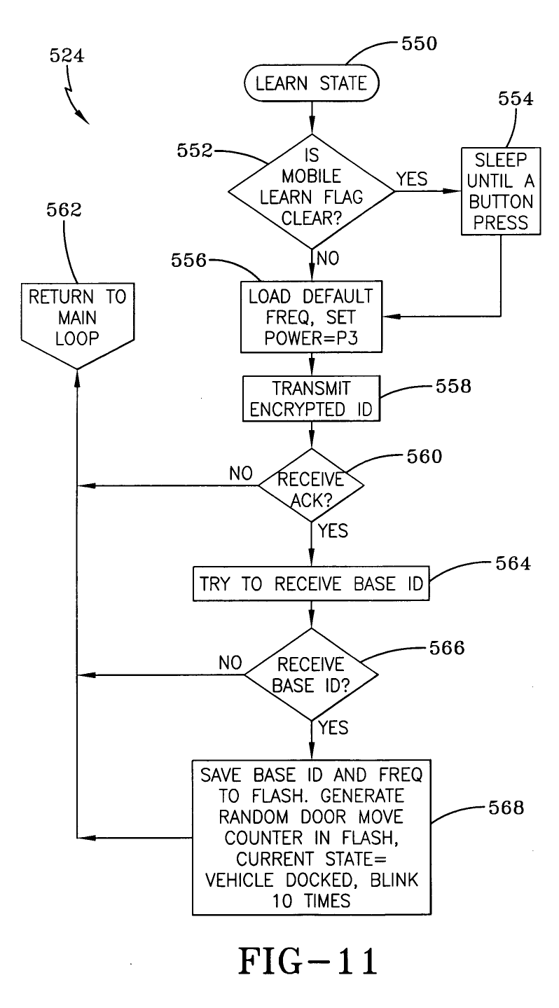

Refining now to FIG. 11, the methodology related to the learning of a mobile transmitter to a base controller 52 is designated generally by the numeral 524. The methodology 524 makes a first inquiry at step 552 as to whether the mobile learn flag is clear or not. If the mobile learn flag is clear, then at step 554 the mobile transmitter 70 enters a sleep condition until a button press—from either button 82 or 83—is detected. If at step 552 the mobile learn flag is not in the clear condition or a button has been pressed to exit the sleep mode, then at step 556 the mobile transmitter 70 loads the default frequency, established at step 310, and the transmit power is set to level P3 at step 556. Next, at step 558, the mobile transponder 76 transmits an encrypted identification code specifically associated with the mobile transmitter. At step 560 the mobile transponder 76 awaits a return transmission or acknowledgment signal from the base controller 52, wherein the acknowledgment signal includes at least the base operator identification code. In other words, in this step the mobile transponder is attempting to establish a communication link with the base controller and if a return acknowledgment signal is not received, then the process returns to the main loop 513 at step 562. However, if a return signal is acknowledged, then at step 564 the mobile processor 72 attempts to authenticate the validity of the base operator identification code contained in the acknowledgment signal. If a valid base identification code is not received at step 566 then the process returns to the main loop 513 at step 562. However, if a valid return base operator identification code is received at step 566, then that base identification code and frequency is saved to the memory 74 at step 568. Additionally, a random door move counter is generated and stored in the flash memory, and the power level is reset to the lowest value P0, and the variable Current State is set equal to Vehicle Docked. The door move counter is utilized as a key within the encryption algorithm so that the learned mobile transmitter is always recognized by the base operator. Upon conclusion of this step, the LED light source 96 blinks a predetermined number of times such as 10. And then the process returns to the main loop 513 at step 562.

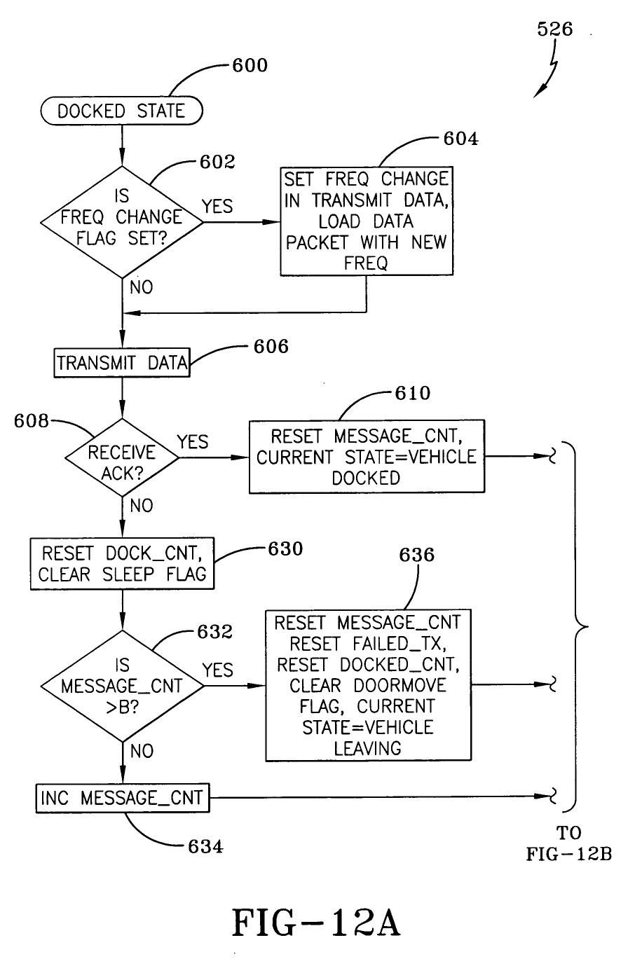

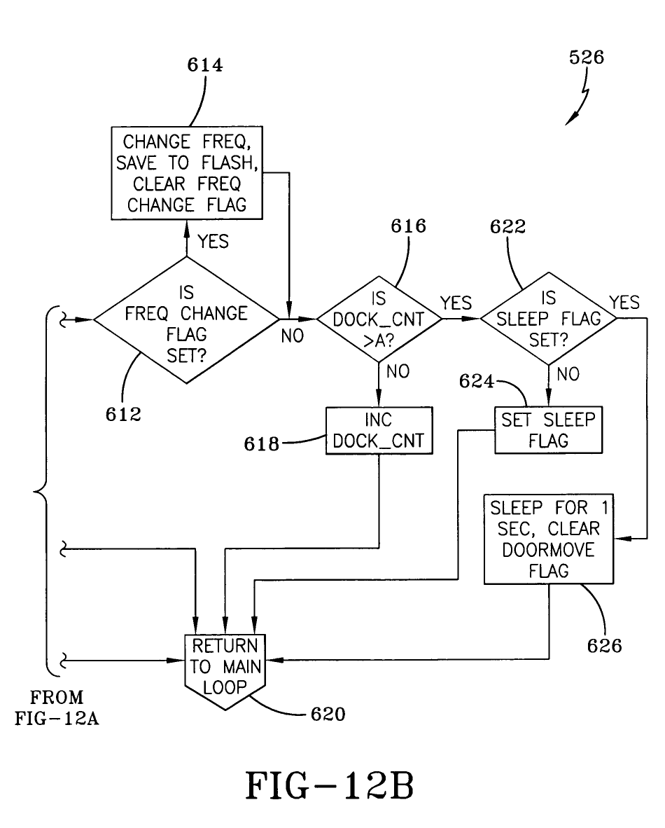

Referring now to FIGS. 12A and 12B, it can be seen that the steps for evaluating a Docked State of the mobile transmitter is designated generally by the numeral 526. This sub-routine starts at step 602 when the processor 72 inquires as to whether the frequency change flag has been set or not. If the frequency change flag has been set, the frequency is changed and all future data transmissions are loaded into a data packet with the new frequency at step 604. In other words, if a new frequency has been selected, the processor 72 changes to the new frequency upon the next data transmission. If the frequency change flag has not been set, or upon completion of step 604, the mobile transponder transmits a data signal at step 606. Next, at step 608 the processor 72 determines whether a return acknowledgment signal is received from the base transceiver 56 or not. If an acknowledgment signal is received, the variable message-count is reset and the variable Current State is set to Vehicle Docked. Next, at step 612, the processor 72 inquires as to whether the frequency change flag has been set and if so, then at step 614 the frequency is changed and saved to the flash memory 74 and the frequency change flag is cleared. In other words, the base operator is safe to change to a new frequency since both the base controller 52 and the mobile processor 72 are aware of the new frequency. If at step 612 the frequency change flag has not been set, or upon completion of step 614, the processor 72 inquires as to whether the variable dock-count is greater than variable A. Variable A may be set at the change sensitivity step or at step 506 and is selected such that a small number value places the system in a one second power saving mode sooner. Accordingly, if the variable dock-count is greater than A, then at step 622 the processor inquires as to whether the sleep flag has been set or not. If the sleep flag has not been set then at step 624 the processor sets the sleep flag. However, if at step 622 the sleep flag has already been set then at step 626 the mobile processor 72 sleeps for one second, or any other predetermined period of time, and the door move flag is cleared. It will be appreciated that the sleep time could be set for a smaller value of time to provide a faster response or a larger value of time to give longer battery life to the mobile transmitter. If at step 616 the dock-count is determined not to be greater than variable A, then at step 618 the dock-count value is incremented and the process returns to the main loop at step 620. Upon completion of steps 624 or 626, the processor proceeds to step 620 and is returned to the main loop 513.

Returning now to step 608, if a return acknowledgment signal is not received from the base transceiver 56, then at step 630 the variable dock-count is reset and the sleep flag is cleared. Following this the variable message-count value is checked and compared to variable B at step 632. Variable B may be selected according to the sensitivity selection at step 506 or it may be preset. A large value for B keeps the mobile transmitter trying to re-establish a docked state and a small value causes the mobile transmitter to change states more quickly. In any event, if the message count variable is not greater than B, then at step 634 the message-count variable value is incremented. However, if at step 632 the message-count value is greater than B, then at step 636 the message-count value is reset, a mobile failed-tx variable value is reset, the docked-count variable value is reset, the door move flag is cleared, and the Current State variable is set to Vehicle Leaving. If the message-count variable is not greater than the variable B at step 632, then at step 634 the message-count variable is incremented by one. Upon completion of steps 634 or 636 the process returns to the main loop at step 620.

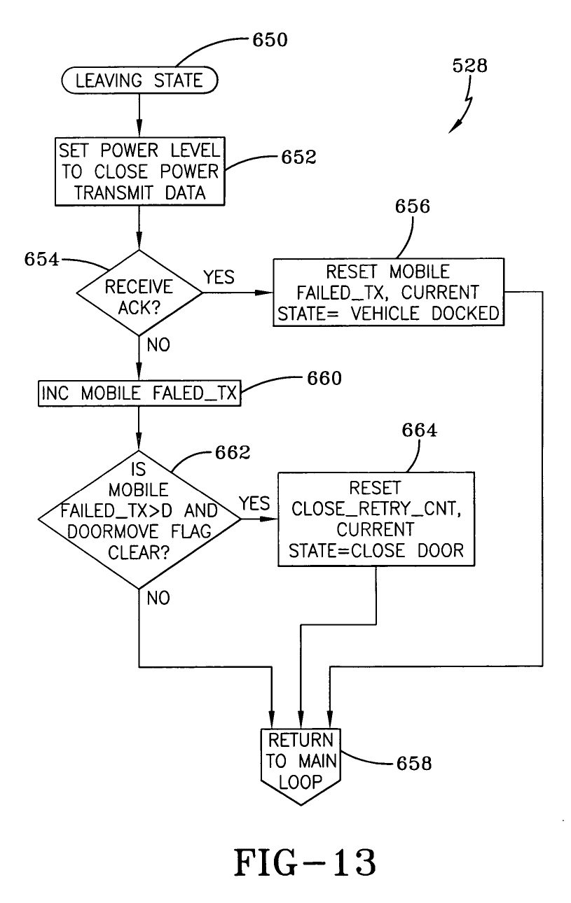

Referring now to FIG. 13, the methodology associated with the Leaving State is designated generally by the numeral 528. This methodology starts at step 652 where the power level is set to a closed power transmit data as determined by the sensitivity setting established at step 414. At step 654, the mobile transmitter awaits an acknowledgment signal which, if received, the mobile failed-tx variable value is reset and the Current State variable is set to Vehicle Docked. Upon completion of step 656 the process proceeds to step 658 and returns to the main loop 513. If, however; at step 654 a return signal is not received, then at step 660 the mobile failed-tx variable is incremented. Next, at step 662, the processor 72 determines whether the mobile failed-tx variable is greater than the variable D and whether the door move flag is in a clear condition. If neither of these criteria are met then the process proceeds to step 658 and returns to the main loop 513. However, if at step 662 the mobile failed-tx is greater then D and the door move flag is clear then the close-retry-count variable is reset and the Current State variable is set equal to Close Door at step 664. It will be appreciated that variable D determines how soon the door closes. Accordingly, a large value for variable D delays the door close actuation.

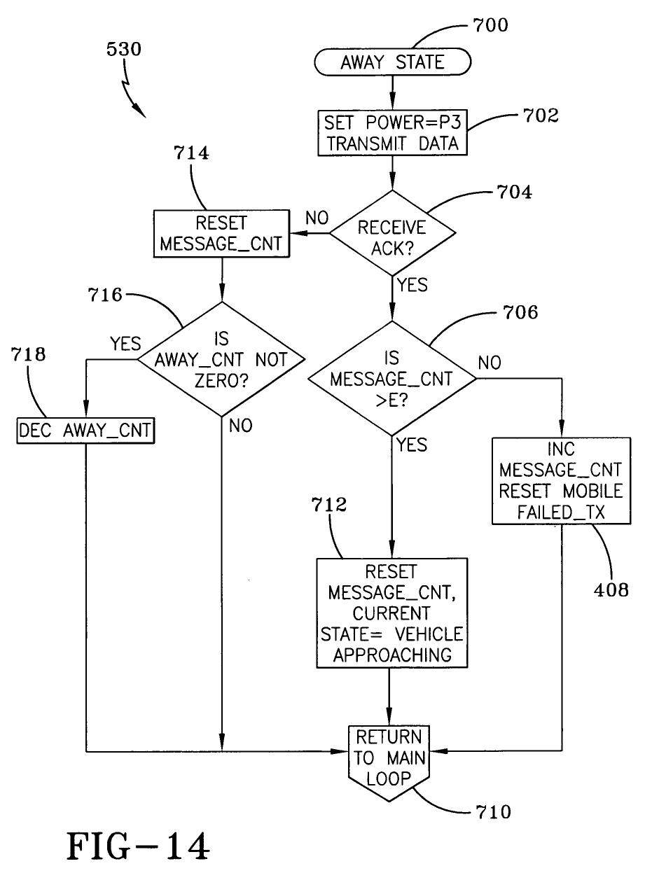

Refining now to FIG. 14, the Away State methodology is designated generally by the numeral 530. The methodology starts at step 702 where the power level is set to P3 and a query signal and associated data is transmitted by the transponder. At step 704 the mobile transponder 76 awaits a return acknowledgment signal and if received then the processor 72 queries as to whether the message-count variable is greater than a variable E. If not, the message-count variable is incremented and the mobile failed-tx variable is reset at step 708. Upon completion of this step the processor returns to the main loop at step 710. However, if at step 706 it is determined that the message-count variable is greater than E, then the message-count value is reset and the Current State value is set equal to Vehicle Approaching at step 712. Upon completion of step 712, the process returns to the main loop 513 at step 710. It will be appreciated that variable E controls the amount of time before changing states. As such, a larger value for variable E will cause the system to take longer to change states.

Returning to step 704, if a return signal is not acknowledged, then at step 704 the message-count variable is reset. Next, at step 716, the processor 72 inquires as to whether the away count variable is equal to zero or not. If the away count variable is equal to zero, the process returns to the main loop 513 at step 710, but if the variable is not equal to zero then the count is decremented at step 718 and then the process returns to the main loop 513 at step 710.

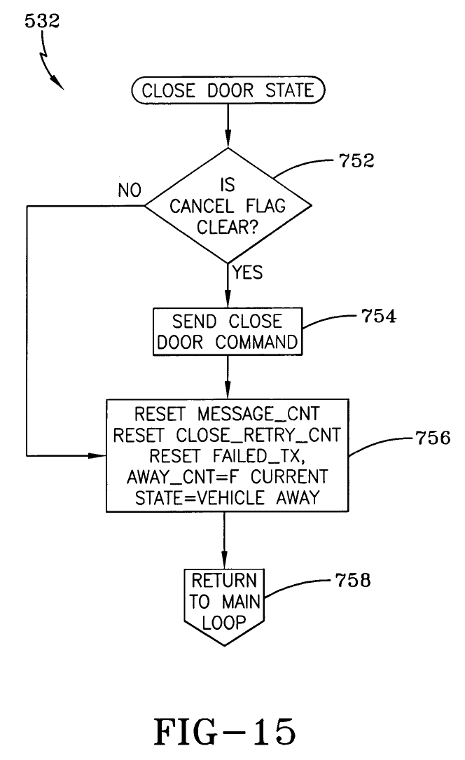

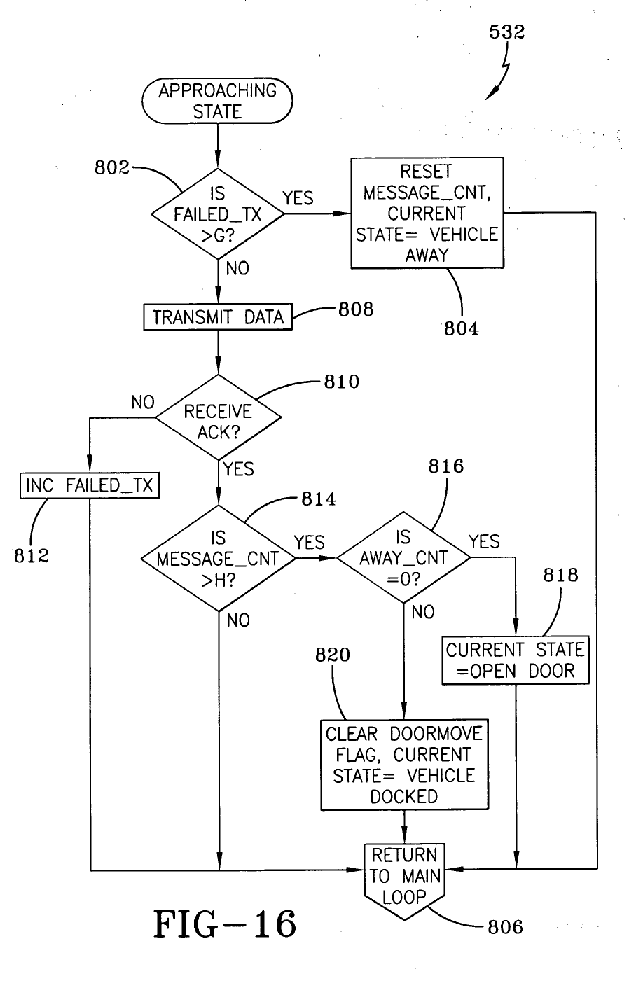

Referring now to FIG. 15, the Close Door State sub-routine is designated generally by the numeral 532. This sub-routine 532 at step 752 inquires as to whether the cancel flag is clear or not. If the cancel flag is clear then at step 754 the mobile transponder generates a close door command. If the cancel flag is not clear, or upon completion of step 754, the processor at step 756 resets the message-count variable, resets the close-retry-count variable, resets the mobile failed-tx variable, and sets the away count variable to a value of F. And finally, the Current State variable is set to Vehicle Away. It will be appreciated that the variable F is selected so as to adjust the time that the mobile transponder must be gone or away from the garage door enclosure before the base controller is allowed to open the door again. Upon completion of step 756 the process proceeds to step 758 and returns to the main loop 513.

Referring now to FIG. 16, it can be seen that the Approaching State methodology is designated generally by the numeral 532. The methodology 532, at step 802, queries as to whether the mobile failed-tx variable is greater than a value of G. Variable G sets the time for going back to the Away State if communication is lost between the mobile transmitter and the base operator. If the number of failed transmissions is greater than G, then at step 804 the message-count variable is reset and the Current State is set to Vehicle Away. Upon completion of step 804, the process returns to the main loop 513 at step 806. However, if at step 802 it is determined that the number of failed transmissions is not greater than G, then at step 808 the power level is set to the sensitivity level for opening the door as established in step 414 and a transmission signal is sent at step 808. Accordingly, the processor queries at step 810 as to whether a return acknowledgment signal is received from the base transceiver 56. If no return signal is received, then at step 812 the mobile failed-tx variable is incremented and the process returns to the main loop 513 at step 806. But, if a return acknowledgment signal is received, then at step 814 the processor queries as to whether the message-count variable is greater than a variable H or not. If it is not greater than H, then the process returns to step 806. It will be appreciated that variable H allows for the adjustment of the delay before opening the door. In any event, if the message-count is greater than H, then at step 816 the processor queries as to whether the away-count variable has been fully decremented to zero or not. If so, then the Current State variable is reset by the processor 72 to the Open Door State at step 818 and the process returns to the main loop 513 at step 806. In other words, the door has been closed for an adequate period of time and the door is permitted to open. However, if at step 816 the away-count value is not equal to zero then at step 820 the door move flag is set to clear and the Current State variable is set to Vehicle Docked. And upon completion of step 820 the process returns to the main loop 513 at step 806.

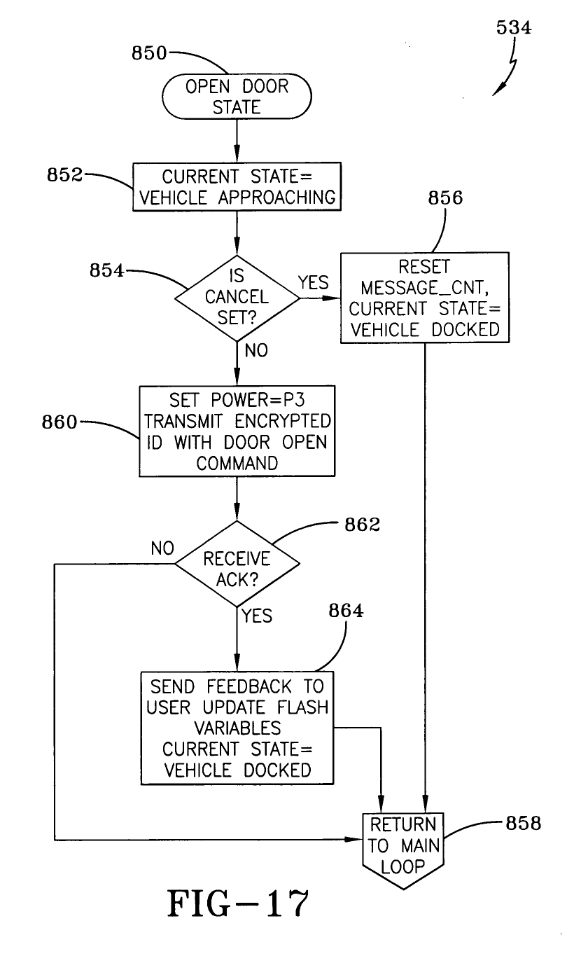

Referring now to FIG. 17, it can be seen that the methodology for opening a door is designated generally by the numeral 534. First, at step 852 the Current State variable is set to Vehicle Approaching. At step 854 the processor 72 inquires as to whether the cancel flag has been set or not. If so, then at step 856 the message-count variable is reset and the Current State value is set to Vehicle Docked. Upon completion of step 856, the process returns to the main loop 513 at step 858. However, if the cancel flag is not set at step 854 the power level is set to the highest power level P3 and an encrypted identification transmission is sent with a door open command at step 860. If a return signal is acknowledged at step 862, then the base controller 52 sends the appropriate feedback and the flash variables are updated. Upon completion of step 864 the process returns to the main loop 513 at step 858. If however, at step 862 a return signal is not acknowledged upon transmission of a door open command, then the process returns to the main loop at step 858.

In considering the various states of the mobile transmitter, it will be appreciated that the Learn State is only used initially when the mobile transmitter and the base operator are learned to one another. Upon completion of the Learn State, the mobile transmitter will cycle through the other six states according to the operating condition of the carrying device and its position. The following operational scenario is provided only as an example, as it will be appreciated that various other scenarios could be implemented by states of the mobile transmitter and depending upon the operation or status of the carrying device. In any event, after initial programming, it is presumed that the carrying device is stored in the garage in a Docked position. When a user desires to leave the garage, presumably they will open the garage door by utilizing an open button provided by the wall station transmitter. In the alternative, an auto-open feature may be utilized wherein the activity sensor or ignition sensor detects a change in the operational status of the vehicle and causes the door to open automatically. In any event, presuming that the garage door is open and the vehicle is in the Docked condition as represented in FIGS. 12A and 12B, the mobile transmitter will begin transmitting data such that if the base operator responds, then the Current State remains in the Vehicle Docked condition and this process is repeated continually. However, if the base operator return signals are not acknowledged, and a message count variable exceeds a predetermined variable value, such as variable B, then a Vehicle Leaving State is established and the mobile transmitter begins execution of the steps shown and described in FIG. 13.

In the Vehicle Leaving State, the mobile transmitter utilizes one of the power level settings set in the sensitivity program and repeatedly attempts to generate a signal so that if a received signal is acknowledged, the Current State is reverted back to the Vehicle Docked State. However, if the transmitted signals are not acknowledged, then the Current State is set to the Close Door State, and it is presumed that the vehicle has traveled a far enough distance so as to initiate the close door operation without the user having to manually actuate a remote transmitter button.

In the Close Door State, the close door command is sent and various variables are reset and the Current State variable is set to Vehicle Away.

In the Vehicle Away condition, the mobile transmitter continually attempts to attain the Vehicle Approaching State which is shown and described in FIG. 16. In this state, if signals are initially received but then are failed to be acknowledged, the Current State reverts back to the Vehicle Away State. However, if the power level transmission, which is set to the sensitivity open setting, establishes that the vehicle is in fact approaching, then the vehicle Current State is set to Open Door. It should be noted that this state can only be attained if the vehicle has been away for a predetermined period of time as established by the away count variable.

In the Open Door State, the Current State is reset to Vehicle Approaching and then the open command is generated which, if acknowledged, allows for the setting of the Current State back to Vehicle Docked. However, if the open door command signal is not acknowledged, then the Current State returns to the Vehicle Approaching State and the Open Door State is ultimately repeated. In this manner, the true desire of the user to have the door open can be established. It will further be appreciated that when the mobile transmitter is in the Vehicle Approaching State, if the away count is not away long enough then the State will return to the Vehicle Docked State so as to prevent a misinterpretation of the mobile transmitter's movement in areas close to the garage or enclosure. This is beneficial inasmuch as someone passing by their house may have a short driveway, and recognition of the mobile transmitter may not want to be immediate.

Based upon the foregoing description and operation of the mobile transmitter, it will be appreciated that numerous advantages are realized by the disclosed hands free operation system. A particular advantage is that the mobile transmitter initiates the communications with the base operator. This reduces electrical noise that would otherwise be constantly generated by base operators that are always transmitting as proposed in various other hands free systems. These mobile transmitters are only on when an appropriate activity, such as provided by an ignition sensor, vibration sensor or other observable phenomenon of the carrying device. Accordingly, this saves on battery power utilized by the mobile transmitter and only enables the mobile transmitter when the carrying device is considered to be in operation. Yet another advantage of the mobile transmitter is that it is able to transmit signals at different power levels so as to allow for finer control as to when to open or close a movable barrier. Use of acknowledgment signals from the base operator further facilitate this finer control. The mobile transmitter is also advantageous in that it provides for overriding of the hands free operations and allows for setting of the sensitivity associated with power levels, and if desired, setting of various variable count parameters so as to adjust for when the doors should undergo a movement. Use of these counters allows for confirmation of the various operating states and ranges in operating states to ensure a robust operation of the hands free system. In other words, the counters ensure the intention of the carrying device before undertaking a door move operation.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

What is claimed is:

1. An operator system for automatically controlling access barriers, comprising:
a base controller associated with at least one access barrier;
at least one base transceiver associated with said base controller; and
at least one remote transmitter periodically generating query signals, said at least one base transceiver in response to said query signals generating acknowledgment signals which are received by said at least one remote transmitter which subsequently generates movement commands to said base controller based upon receipt of a predetermined number of said acknowledgment signals.

2. The system according to claim 1, wherein said at least one remote transmitter generates at least two different power level query signals, wherein one of said different power level signals is used to generate a first direction movement command and the other of said different power level signals is used to generate a second direction movement command.

3. The system according to claim 2, wherein said at least one remote transmitter comprises:
a processor;
a transponder connected to said processor, said transponder generating said query signals and receiving said acknowledgment signals; and
a first button connected to said processor which when actuated cancels said movement commands.

4. The system according to claim 3, wherein said at least one transmitter further comprises:
a second button connected to said processor which when actuated initiates said movement commands.

6. The system according to claim 4, wherein actuation of said first button for a predetermined period of time selects specific power levels associated with said direction movement commands.

7. The system according to claim 6, wherein said remote transmitter has four different power levels to select from.

8. The system according to claim 4, wherein actuation of said second button for a predetermined period of time enables learning of said remote transmitter to said base controller.

9. The system according to claim 3, wherein said processor maintains a plurality of count variables wherein at least one of said count variables is used to count receipt of said acknowledgment signals and upon reaching appropriate values generating said movement commands.

10. The system according to claim 9, wherein said processor maintains a Current State variable which is adjusted according to said plurality of count variables.

11. The system according to claim 10, wherein said Current State is set to one of the following: aLeam State, Vehicle Docked, Vehicle Leaving, Vehicle Away, Vehicle Approaching, Close Door or Open Door.

12. The system according to claim 11, wherein said Vehicle Leaving state is associated with one of said power level signals and said Vehicle Approaching state is associated with a different one of said power level signals.

13. The system according to claim 3, wherein said at least one remote transmitter further comprises:
an activity sensor connected to said processor, said processor sending said query signals only when said activity sensor determines that a device carrying said remote transmitter is on.

14. The system according to claim 13, wherein said activity sensor comprises:
a vibration sensor that generates a vibration signal received by said processor indicating that the device is on.

15. The system according to claim 13, wherein said activity sensor comprises:
an electrical noise sensor that generates a noise signal received by said processor indicating that the device is on.

16. The system according to claim 13, wherein said activity sensor comprises:
an ignition sensor that detects an ignition signal which is sent to said processor indicating that the device is on.

17. The system according to claim 2, wherein said signals communicated between said base transceiver and said remote transmitter are within a range of frequencies which is separable into a plurality of channels, and wherein said base controller selects one of said channels.

18. The system according to claim 17, wherein each said channel has a bandwidth of about 0.5 MHZ and said range of frequencies is between about 902 MHZ to about 928 MHZ.

19. The system according to claim 2, wherein said signals communicated between said base transceiver and said remote transmitter are encrypted.
